(19) United States
(12) Patent Application Publication
(10) Pub. No.: US 2012/0043165 A1
(43) Pub. Date: Feb. 23, 2012

(54) ELEVATOR INSTALLATION DOOR OPERATION

(75) Inventor: Juan Carlos Abad, Rotkreuz (CH)

(73) Assignee: INVENTIO AG, Hergiswil (CH)

(21) Appl. No.: 13/034,068

(22) Filed: Feb. 24, 2011

(30) Foreign Application Priority Data
Mar. 1, 2010 (EP) 10155020.0

(51) Int. Cl. B66B 13/16

(52) U.S. Cl. 187/316

(57) ABSTRACT

An elevator installation can comprise an elevator cage, elevator doors, a drive, an elevator control and a counterweight, which is movable in opposite direction to the elevator cage. The elevator control comprises a door control module or is connectible with a door control module, which determines a standard door keeping-open time or an extended door keeping-open time depending on the respective load situation of the elevator cage.

### CROSS-REFERENCE TO RELATED APPLICATION

This application claims priority to European Patent Application No. 10155020.0, filed Mar. 1, 2010, which is incorporated herein by reference.

### FIELD

The disclosure relates to operation of a door of an elevator installation and to a corresponding elevator installation.

### BACKGROUND

Elevator installations can be a significant consumer of power in a building. The overall efficiency of an elevator installation is made up of the following two essential components: energy consumption in travel operation and stand-by consumption.

The power consumption of an elevator installation in idle running, i.e. when traveling empty, is frequently taken into consideration. However, for overall consumption the consumption which results from journeys (termed journey energy consumption) with different load states also plays a role.

U.S. Pat. No. 3,365,025 shows an elevator installation in which a door keeping-open time of a elevator cage is prolonged if a person in this elevator cage has made a story selection. The possibility is thus provided for further persons to use the elevator installation for an envisaged elevator journey.

There are various approaches, which for example operate with energy stores for recuperation of braking energy, in order to provide some degree of reduction in energy consumption. Overall, however, there is a desire to further reduce energy consumption.

### SUMMARY

In at least some cases, the disclosed technologies are based on the recognition that overall consumption can be reduced by a form of “traffic control”. In this form of traffic control, which is propagated here, the instantaneously present loading of the elevator cage can, in particular, be taken into consideration.

On the one hand, elevator journeys in which the elevator cage travels downwardly in an empty state or with a small load can have the consequence of high energy consumption and therefore count as inefficient trips. However, inefficient trips can also include upward journeys with a small load or with few passengers or even with only a single passenger. The reason for that can be that for a given level of upward traffic, journeys with a small load require a correspondingly higher number of trips, wherein each upward journey can have the consequence of an empty downward journey with correspondingly high energy consumption. These effects, which can arise analogously also in the case of temporary presence of downward traffic with a lightly laden elevator cage and therefore inefficient downward journeys, are explained in more detail in later sections of this description.

In the case of a downward journey with an empty or only lightly laden elevator cage (empty downward journey) a relatively high motor power is required, which can be equated with relatively high energy consumption associated with a specific travel distance. This is due to the fact that in the case of such an empty downward journey the counterweight is usually moved upwardly in the elevator shaft, which counterweight in most elevator installations can have a weight which is greater than the weight of the empty elevator cage. With such a design of the counterweight it can be taken into consideration that the elevator cage is typically moved at approximately 50% of the rated load. In this case the weight of the counterweight is selected to that a balanced state arises with loading of the elevator cage at 50% of the rated load.

In this description, it should be understood that a balanced state is a load state of the elevator installation in which the weight of the counterweight corresponds with the total weight of the elevator cage. The total weight of the elevator cage in that case comprises the empty weight of the elevator cage and the weight of a load present in the elevator cage (useful load).

Elevator installations can be designed so that a balanced state between elevator cage and counterweight is present when the elevator cage is loaded to, for example, approximately 50% or 40% or 30% of the rated load of the elevator cage.

In some embodiments, an elevator installation is operated or controlled in such a manner that as many elevator journeys as possible take place with a loading of the elevator cage in which the load state of the elevator installation corresponds as far as possible with the balanced state. The number of inefficient journeys shall thus be reduced and the number of efficient journeys increased. This is achieved by a correction or adaptation of the door keeping-open times. Before an elevator cage with a small load starts on an inefficient elevator journey, the probability of additional passengers boarding can be increased by a prolongation of the door keeping-open time.

That can be achieved by an operating method which can comprise the following method steps:
providing the elevator cage on a story,
opening the elevator doors to enable loading of the elevator cage,
detecting an instantaneously present loading of the elevator cage and
adapting a door keeping-open time in dependence on the instantaneously present loading of the elevator cage.

By the term “instantaneously present loading of the elevator cage” is to be understood the weight of the load of the elevator cage detected by a load measuring device after elapsing of a standard door keeping-open time tₛₜₐ.

By the term “door keeping-open time” is to be understood that period of time during which the elevator doors are, after complete opening thereof, kept open before a closing process can take place. Denoted as “standard door keeping-open time” is a fixed or settable door keeping-open time which is always used when the instantaneously present loading of the elevator cage lies above a settable predetermined value (threshold value).

According a variant of embodiment of the technology the door keeping-open time is adapted in accordance with the following rule:
if the instantaneously present loading of the elevator cage lies below a settable threshold value use is made of a settable maximum door keeping-open time tₘₐₓ lying above a predetermined standard door keeping-open time tₛₜₐ.

The probability can thus be increased that at least one further passenger boards, so that the efficiency of the subsequent elevator journey and of the entire elevator operation is improved. Possibly, the threshold value is settable within a load range lying between zero load and the load for the balanced state.

According to a variant of embodiment of the method the door keeping-open time is adapted in accordance with the following rule: if the instantaneously present loading of the elevator cage lies below a settable threshold value, use is made of a variable door keeping-open time tᵥₐᵣ, the duration of which lies between a settable maximum door keeping-open time tₘᵢₙ and a settable maximum door keeping-open time tₘₐₓ and is substantially inversely proportional to the instantaneously present loading.

The door keeping-open times tₘₐₓ and also tₘᵢₙ in that case both lie above the standard door keeping-open time tₛₜₐ.

Through the use of this method the probability can similarly be increased that at least one further passenger boards, so that the efficiency of the subsequent elevator journey and also of the further operational sequence influenced by this elevator journey is improved. The door keeping-open time is in this embodiment optimized by adaptation to the degree of under-loading of the elevator cage. The threshold value can be settable within a load range lying between zero load and the load in the balanced state.

According to a further embodiment of the method use is made of a so-termed standard door keeping-open time tₛₜₐ when the instantaneously present loading of the elevator cage exceeds the settable threshold value.

According to a further embodiment of the method use is made of a so-termed standard door keeping-open time tₛₜₐ when the instantaneously present loading of the elevator cage corresponds approximately with the load in the balanced state or a greater load, i.e. when the weight of the current load (for example, approximate 50% of the rated load) together with the empty weight of the elevator cage corresponds approximately with the total weight of the counterweight or an even higher weight.

According to an embodiment of the method the possibility of a passenger, who has boarded, being able to cause premature door closing by actuation of a signal transmitter, for example a button, is suppressed. It is thus achieved that an extension of the door keeping-open time cannot be prevented by passengers.

### BRIEF DESCRIPTION OF THE DRAWINGS

The technologies are further explained in the following by several exemplifying embodiments with reference to the figures.

FIG. 1A shows a simplified illustration of an elevator installation in a first load state during a downward journey (journey in empty state);

FIG. 1B shows a simplified illustration of an elevator installation according to FIG. 1A in a first load state during an upward journey (journey in empty state);

FIG. 2A shows a simplified illustration of the elevator installation according to FIG. 1A in a second load state during a downward journey (journey in balanced state);

FIG. 2B shows a simplified illustration of the elevator installation according to FIG. 1A in a first load state during an upward journey (journey in balanced state);

FIG. 3A shows a simplified illustration of the elevator installation according to FIG. 1A in a third load state during a downward journey (journey in a part-load state);

FIG. 3B shows a simplified illustration of the elevator installation according to FIG. 1A in a third load state during an upward journey (journey in a part-load state); and

FIG. 4 shows an illustration of a further elevator installation with a block-diagram illustration of the elevator control.

### DETAILED DESCRIPTION

For explanation of the present disclosure the energy consumption per journey is determined in the following simplified form. These are merely examples of counting, which serve for explanation. In the case of actual use the count values can be established with consideration of the actual elevator constellation.

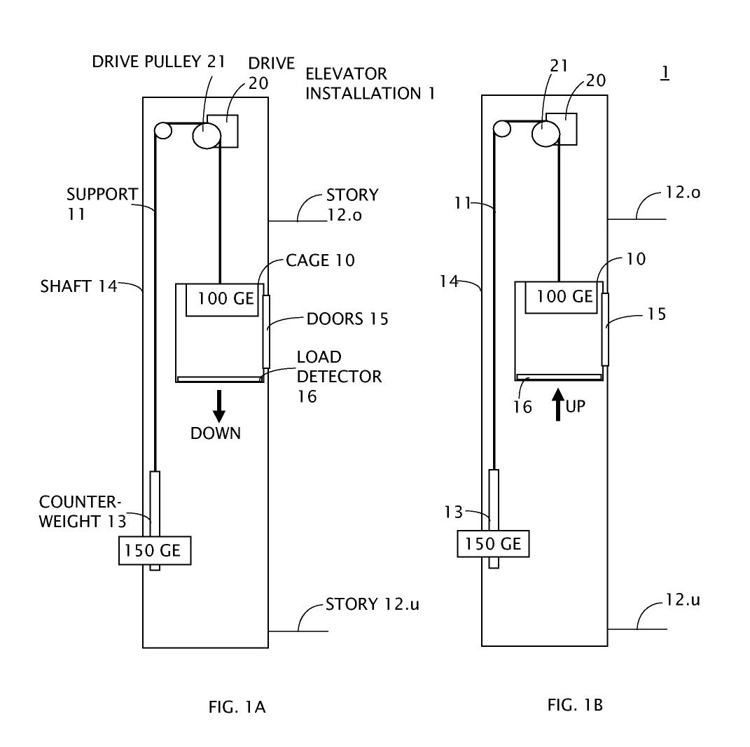

The starting point is an elevator installation 1 as illustrated in FIG. 1A. This is an elevator installation 1 with an elevator cage 10, elevator doors 15 (cage and shaft doors) and a counterweight 13, which moves in opposite direction to the elevator cage 10. A drive 20 drives, by way of a drive pulley 21, a support means 11 by which the elevator cage 10 and the counterweight 13 are connected together, carried and driven.

In order to be able to illustrate in simple mode and manner how the energy consumption of an elevator installation can be reduced, there will be assumed a configuration in which the elevator cage 10 has an empty weight LG=100 GE (GE=units of weight). One GE can be, for example, 1 kilogram. The counterweight 13 here has a weight GG=150 GE.

Not taken into consideration in the following examples are influencing variables such as friction, slip, stand-by consumption, energy consumption in door opening and closing, and other factors. The concern in the following is primarily the journey energy consumption which results from the upward and downward movement of masses (weights), i.e. primarily consideration of changes in the potential energies of the elevator cage and the counterweight.

A situation is shown in FIG. 1A (1st case) in which the elevator cage 10 is in the course of a downward journey AB. The elevator cage 10 is empty, i.e. this is an empty downward journey. Since at the same time the counterweight 13 has to be moved upwardly, an energy equivalent of 50 EE (EE=unit of energy) is expended here for a specific travel distance, since 150 GE (of the counterweight) are moved upwardly and 100 GE (of the elevator cage) are moved downwardly. The value of a unit of energy EE can be indicated, for example, in kWh. Here these are not absolute considerations, but relative considerations.

A situation is shown in FIG. 1B (2nd case) in which the elevator cage 10 is in the course of an upward journey AUF. The elevator cage 10 is empty, i.e. it is an empty upward journey. Since at the same time the counterweight 13 has to be moved downwardly, here there is no expenditure of drive energy (energy equivalent of 0 EE), since the counterweight 13 is heavier than the empty weight of the elevator cage. In this case it can even be possible to recover energy if, for example, an energy recuperation system is present.

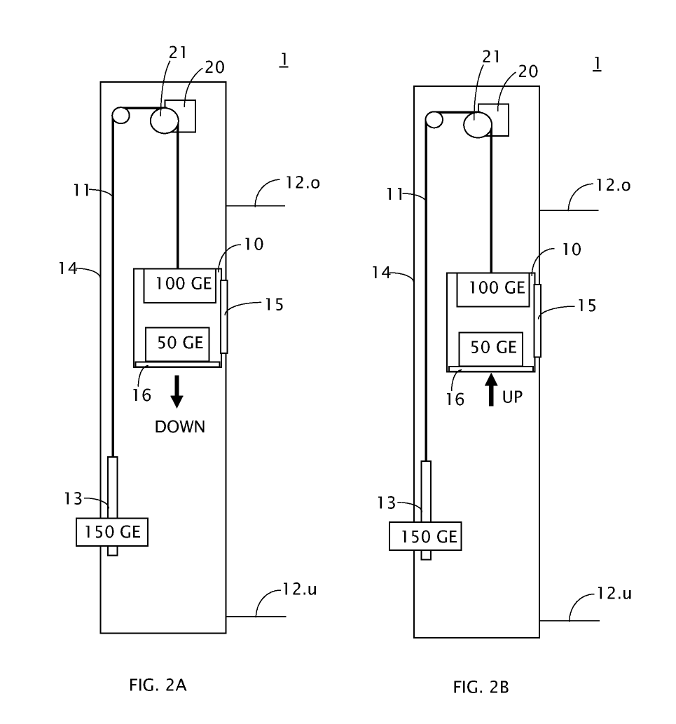

A situation is shown in FIG. 2A (3rd case) in which the elevator cage 10 is in the course of a downward journey AB. The elevator cage 10, with its empty weight of 100 GE, is laden with a useful load of 50 GE. Since at the same time the counterweight 13 with its 150 GE has to be moved upwardly, there is here a balanced journey. No drive energy is expended for the journey (energy equivalent of 0 EE). Here, for example, four passengers are located in the elevator cage 10, the total weight (useful load) of which corresponds with 50 GE.

A situation is shown in FIG. 2B (4th case) in which the elevator cage 10 is in the course of an upward journey AUF. The elevator cage 10, with its empty weight of 100 GE is laden with a useful load of 50 GE. Since at the same time the counterweight 13, with its 150 GE, is moved downwardly, there is similarly a balanced journey here. No drive energy is expended (energy equivalent of 0 EE) for the journey, since the counterweight 13 is as heavy as the elevator cage 10 with the useful load of 50 GE.

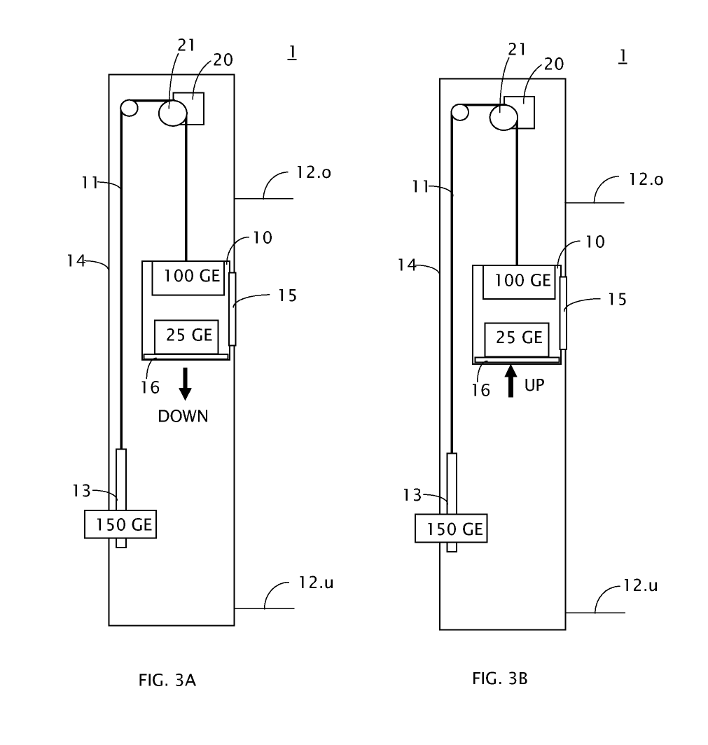

A situation is shown in FIG. 3A (5th case) in which the elevator cage 10 is in the course of a downward journey AB. The elevator cage 10 is laden with a useful load of 25 GE, i.e. there is a downward part-load journey AB in which the total weight of the elevator cage 10 (100 GE+25 GE) is smaller than the weight GG of the counterweight of 150 GE. This load situation is termed part-load state. Since the counterweight 13 with its 150 GE has to be moved upwardly, here an energy equivalent of 25 EE is expended for the stated specific travel distance. Here, by way of example, two passengers are located in the elevator cage 10, the total weight of which corresponds with 25 GE.

A situation is shown in FIG. 3B (6th case) in which the elevator cage 10 is in the course of an upward journey AUF. The elevator cage 10 is laden with a useful load 25 GE (part-load state), i.e. there is an upward part-load journey AUF in which the total weight of the elevator cage 10 (100 GE+25 GE) is smaller than the weight GG of the counterweight of 150 GE. Since in the case of the part-load upward journey of the elevator cage 10 the counterweight 13 is moved downwardly at the same time, no drive energy is expended here (energy equivalent of 0 EE), since the counterweight 13 is heavier than the elevator cage with the useful load. In this case as well energy can be recovered if the elevator installation is equipped with an energy recuperation system.

In cases 2, 3, 4 and 6 no energy is expended (according to simplified calculations), since in an upward journey AUF of the elevator cage 10 either the counterweight 13 is at least as heavy as the total weight of the elevator cage 10 or since, in the case of a downward journey AB of the elevator cage 10, the elevator cage 10 with the instantaneously present loading has the same weight as or is heavier than the counterweight 13. In the other cases 1 and 5, energy is expended.

It is of interest to establish on the basis of this simplified form of calculation that in cases 1 and 5 the expenditure of energy for a defined travel distance is proportional to the instantaneous weight difference between the total weight of the elevator cage and the weight of the counterweight (in the 1st case 50 GE and in the 5th case 25 GE). This also applies to actual elevator installations 1.

It is also of interest to establish that a positive expenditure of energy (i.e. an energy consumption) usually arises when the counterweight 13 is transported upwardly, i.e. in the case of a downward journey AB of the elevator cage 10. However, this applies only when the elevator cage 10 is not more heavily laden than in the case of a balanced travel.

In some cases, it can be assumed that the number of journeys in empty state or inefficient journeys (such as, for example, the cases 1 and 5) are kept as small as possible and the number of efficient journeys (such as, for example, the cases 2, 3, 4, 6) are to be maximized as far as possible.

However, in that case it can be taken into consideration that, for example, with the start of the work day and its predominantly upward traffic incidence in an office building, usually a downward, empty journey follows an upward journey of the elevator cage 10 in order to make the elevator cage 10 available again at the lowermost story 12.u, so that further persons can be transported upwardly. At the end of the work day, with predominantly downward traffic incidence, the elevator cage 10, typically laden from one of the upper stories, will travel downwardly; and, consequently, upwardly again from below in the empty state. It can therefore be assumed in numerous operational situations that the journeys with laden cage have the consequence on each occasion of a journey in empty state with highest possible expenditure of energy.

Measures can be undertaken to have the effect that elevator journeys take place as often as possible with loading of the elevator cage, which as far as possible approaches loading for a balanced journey. Thus, it can be achieved on the one hand that a significant part of the elevator journeys is performed in each instance with smallest possible energy consumption. On the other hand, at the same time, a reduction of the total number of elevator journeys required for a given level of traffic is achieved in that it is sought as far as possible to avoid elevator journeys with an inefficient, small number of passengers.

According to some embodiments, such a measure comprises that at a stop of the elevator cage 10 at a story 12.o, 12.u the door keeping-open time of the elevator doors 15 is controlled in dependence on the detected instantaneously present useful load in the elevator cage 10, i.e. in dependence on the detected loading situation of the elevator cage. Stated in simple terms, in the case of a detected small loading (useful load) of the elevator cage 10 an extended door keeping-open time shall come into use after expiry of the standard door keeping-open time Tₛₜₐ. The probability can thus be increased that in the case of instantaneous small loading still further passengers board before the elevator doors close and the journey of the elevator cage begins. The probability can thus also be increased that a substantial part of the elevator journeys can be carried out with an energy consumption which is smaller than in the case of an elevator journey with, for example, a single passenger. In particular, however, the probability can also be increased that the entire level of traffic can be managed with a smaller number of elevator journeys, whereby also a smaller number of energy-consuming return journeys in empty state results.

On the basis of the considerations explained in the foregoing the following rules can be established for the drive control, i.e. for operation of the elevator installation 1.
Rule 1:
In the case of an elevator cage 10 which has stopped at a story 12.o, 12.u and opened the elevator doors 15, a settable maximum door keeping-open time tₘₐₓ lying above a predetermined standard door keeping-open time tₛₜₐ comes into use if the instantaneously present loading of the elevator cage 10 lies below a settable threshold value.

Through the use of this first Rule the probability can be increased that further passengers board and the elevator cage 10 does not begin its intended journey with a minimum load. In this manner the number of journeys with a small load (for example, with a single passenger) and high energy consumption and as a consequence also the number of return journeys in empty state with highest energy consumption can be reduced.

According to some embodiments, thus prior to each journey after expiry of a standard door keeping-open time tₛₜₐ the instantaneously present loading of the elevator cage 10 is detected. Adaptation of the door keeping-open time takes place on the basis of this information.
Rule 2:
In the case of an elevator cage 10 which has stopped at a story 12.o, 12.u and opened the elevator doors 15, if the instantaneously present loading of the elevator cage 10 lies below a settable threshold value, use is made of a variable door keeping-open time tᵥₐᵣ, the duration of which lies between a settable minimum door keeping-open time tₘᵢₙ and a settable maximum door keeping-open time tₘₐₓ and is substantially inversely proportional to the instantaneously present loading.

This Rule is advantageous to the extent that the elevator doors remain open longer the smaller the instantaneously present loading of the elevator cage, which increases the probability that the elevator cage does not have to execute its intended journey with an extremely low loading. Moreover, a maximum door keeping-open time does not come into use if an instantaneous loading is present which is relatively high, but which still lies below the threshold value.
Rule 3:
In the case of an elevator cage 10 which has stopped at a story 12.o, 12.u and opened the elevator doors, the standard door keeping-open time tₛₜₐ or a standard door keeping-open time tₛₜₐ unchanged comes into use if the instantaneously present loading of the elevator cage 10 exceeds a settable threshold value.
Rule 4:
In the case of a elevator cage 10 which has stopped at a story 12.o, 12.u and opened the elevator doors, the predetermined standard door keeping-open time tₛₜₐ comes into use unchanged if the instantaneously present loading of the elevator cage 10 approximately corresponds with loading in the balanced state or an even higher loading.

These Rules 1 to 4 can be filed or implemented in a elevator control 30 and/or in a special module 31.

Depending on the respective form of embodiment, detection of the load situation of the elevator cage 10 is carried out by interrogation or evaluation of a load detector 16 of the elevator cage 10 and/or by an indirect detection of the load situation of the elevator cage 10. In the case of indirect detection the number of persons who have entered or left the elevator cage 10 is detected in order to be able to draw a conclusion about the load situation. This can be carried out, for example, by means of a light barrier or a camera-based recognition of persons. It is also conceivable to detect the current load situation in buildings with protected access by contactless reading of proof of identity which every person carries.

These two methods can also be combined in order to be able to make a more precise statement with respect to a load situation.

The method by way of a load detector 16 is preferred, since such a detector 16 is typically present in every elevator cage 10 in order to, for example, be able to recognize an impermissible over-loading of the elevator cage 10.

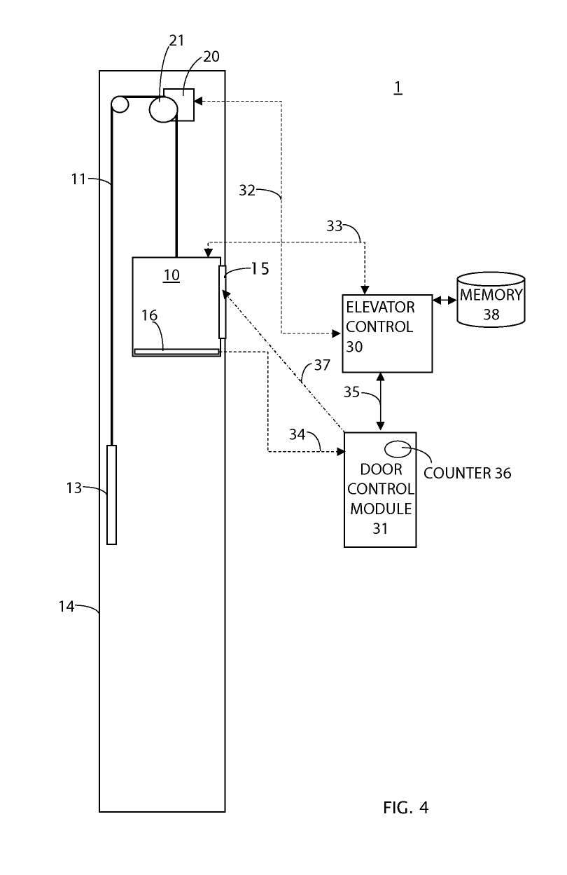

Details of a form of embodiment of an elevator installation are shown in FIG. 4. The details of FIG. 4 can apply to all other embodiments. An elevator control 30 is shown, which monitors the operation of the elevator installation 1 or controls the elevator installation 1. For this purpose there is a connection or link 32 between the elevator control 30 and the drive 20. A further connection or link 33 ensures that the elevator control 30 can obtain a request signal or a travel direction preset from a control panel (not shown) in the elevator cage 10 or at the elevator shaft 14. The load detector 16 supplies, by way of a connection or link 34, to a door control module 31 information about the instantaneous load situation of the elevator cage. The door control module 31 has interaction 35 with the elevator control 30 in order to enable the exchange of information with the elevator control 30 or monitoring by the elevator control. The door control module 31 establishes the door keeping-open time (for example tₛₜₐ, tₘₐₓ or tᵥₐᵣ) which comes into use at that moment. For this purpose it can comprise a timing element or a counter 36 in order to initiate closing of the elevator doors 15 on reaching the door keeping-open time. For this purpose the door control module 31 can switch off, for example, a voltage supply of the door drives (not shown) or supply a pulse to the door drives as illustrated in simplified form in FIG. 4 by the connection/link 37.

The standard door keeping-time tₛₜₐ and/or the respective extended maximum door keeping-open time tₘₐₓ to be used and/or the variable door keeping-open time tᵥₐᵣ can be filed in a memory 38 which, for example, is linked with the elevator control 30, as shown in FIG. 4.

In another embodiment the possibility is suppressed that a passenger in a elevator cage can cause premature door closing by, for example, actuation of an appropriate button. It can thereby be achieved that an advantageous prolonging of the door keeping-open time cannot be prevented by the passengers.

As already mentioned, in some embodiments an elevator installation 1 can be so operated, i.e. so controlled, that the number of inefficient journeys is reduced and the number of efficient journeys increased. In accordance with at least some embodiments of the disclosed technologies this is achieved in that the door keeping-open times, i.e. the times during which the elevator doors 15 stay open, are variable in dependence on the load situation. It is obvious that the level of traffic has no influence or has an influence only to limited extent. However, through the measures of the disclosed technologies it is possible to achieve, under the respectively given circumstances, an optimization with respect to energy consumption, which leads to a detectable saving of energy.

For explanation of the disclosed technologies, illustration has been made of so-called cable elevators which comprise a support means 11 carrying and driving a elevator cage 10. However, the disclosed technologies are also applicable to hydraulic elevators with or without a counterweight.

Having illustrated and described the principles of the disclosed technologies, it will be apparent to those skilled in the art that the disclosed embodiments can be modified in arrangement and detail without departing from such principles. In view of the many possible embodiments to which the principles of the disclosed technologies can be applied, it should be recognized that the illustrated embodiments are only examples of the technologies and should not be taken as limiting the scope of the invention. Rather, the scope of the invention is defined by the following claims and their equivalents. I therefore claim as my invention all that comes within the scope and spirit of these claims.

I claim:

1. An elevator operation method, comprising:
receiving an indication of a current weight of a load of an elevator cage, the elevator cage comprising one or more doors, the one or more doors being at least partially open; and
based at least in part on the received indication, determining a time for closing the one or more doors.

2. The elevator operation method of claim 1, wherein the determining the time for closing the one or more doors comprises:
determining that the current weight of the load of the elevator cage lies below a threshold weight value; and
setting the time for closing the one or more doors according to a maximum time for keeping the one or more doors open.

3. The elevator operation method of claim 1, wherein the determining the time for closing the one or more doors comprises:
determining that the current weight of the load of the elevator cage lies below a threshold weight value; and
setting the time for closing the one or more doors substantially inversely proportionately to the current weight and according to minimum and maximum times for keeping the one or more doors open.

4. The elevator operation method of claim 1, wherein the determining the time for closing the one or more doors comprises:
determining that the current weight of the load of the elevator cage exceeds a threshold weight value; and
setting the time for closing the one or more doors according to a standard time for keeping the one or more doors open.

5. The elevator operation method of claim 1, wherein the determining the time for closing the one or more doors comprises:
determining that the current weight of the load of the elevator cage is approximately equal to or exceeds a weight of a counterweight coupled to the elevator cage; and
setting the time for closing the one or more doors according to a standard time for keeping the one or more doors open.

6. The elevator operation method of claim 1, wherein the indication of the current weight load of the elevator cage is received from a load detector of the elevator cage.

7. The elevator operation method of claim 1, wherein the indication of the current weight load of the elevator cage is determined based at least in part on a number of persons who enter or leave the elevator cage.

8. An elevator installation comprising:
an elevator cage comprising at least one door; and
an elevator control unit, the elevator control unit being coupled to receive door closing time information from a door control module, the door closing time information being based at least in part on a current weight of a load of the elevator cage.

9. The elevator installation of claim 8, further comprising the door control module.

10. The elevator installation of claim 8, further comprising means for measuring the current weight of the load of the elevator cage.

11. The elevator installation of claim 8, further comprising a load sensor coupled to the door control module.

12. The elevator installation of claim 8, wherein the current weight of the load of the elevator cage is below a threshold value, and wherein the door closing time information is based on a maximum time for keeping the one or more doors open.

13. The elevator installation of claim 8, wherein the current weight of the load of the elevator cage is below a threshold value, and wherein the door closing time information is based on an inverse proportion to the current weight and minimum and maximum times for keeping the at least one door open.

14. The elevator installation of claim 8, wherein the current weight of the load of the elevator cage is above a threshold value, and wherein the door closing information is based on a standard time for keeping the one or more doors open.

15. The elevator installation of claim 8, wherein the current weight of the load of the elevator cage is approximately equal to or above a weight of a counterweight coupled to the elevator cage, and wherein the door closing information is based on a standard time for keeping the at least one door open.

16. The elevator installation of claim 8, wherein the elevator installation does not comprise a counterweight coupled to the elevator cage.

17. The elevator installation of claim 8, further comprising a counterweight coupled to the elevator cage.

18. An elevator system component comprising:
a door control module, the door control module being configured to determine an elevator cage door closing time based at least in part on an indication of a current weight of a load of an elevator cage.

19. A method of operating an elevator installation, the elevator installation comprising an elevator cage, elevator doors and a counterweight, the counterweight being configured to move in opposite direction to the elevator cage, the method comprising:
opening the elevator doors to enable loading of the elevator cage at a story served by the elevator installation;
detecting an instantaneously present loading of the elevator cage; and
adapting a door keeping-open time based on the instantaneously present loading of the elevator cage.
